(19) United States
(12) Patent Application Publication
(10) Pub. No.: US 2010/0307056 A1
(43) Pub. Date: Dec. 9, 2010

(54) Modular Planting and Irrigation Device, System and Method

(76) Inventor: Joe D. Byles, New Braunfels, TX (US)

Correspondence Address: GUNN, LEE & CAVE, P.C., 300 CONVENT ST., SUITE 1080, SAN ANTONIO, TX, 78205, US

(21) Appl. No.: 12/859,395

(22) Filed: Aug. 19, 2010

Related U.S. Application Data
(63) Continuation-in-part of application No. 11/998,119, filed on Nov. 28, 2007, now Pat. No. 7,682,103.
Application No. 11/998,119 is a continuation-in-part of application No. 10/600,625, filed on Jun. 20, 2003, now Pat. No. 7,407,340.
(60) Provisional application No. 60/390,097, filed on Jun. 20, 2002.
(60) Provisional application No. 61/302,480, filed on Feb. 8, 2010.

(51) Int. Cl. A01G 9/02; B23P 11/00

(52) U.S. Cl. 47/65.7; 47/65.9; 47/66.7; 29/428

(57) ABSTRACT

A modular planting and irrigation device, system, and method for growing gardens on elevated rooftop surfaces and other surfaces and method of the same. The system has at least one body of porous material with spaces that trap air within the body as water moves therethrough. The water is contained within the body of porous material with a barrier positioned adjacent the side and bottom surfaces of the body. The pore spaces are of sufficient size to allow plant roots to grow therethrough.

### CROSS-REFERENCES TO RELATED APPLICATIONS

This original, nonprovisional application is a continuation-in-part application that claims the benefit of U.S. application Ser. No. 11/998,119 filed Nov. 28, 2007, which is in turn a continuation-in-part application of U.S. application Ser. No. 10/600,625 filed Jun. 20, 2003 (now U.S. Pat. No. 7,407,340), which in turn claims the benefit of U.S. Provisional Application Ser. No. 60/390,097 filed Jun. 20, 2002 (now abandoned). This application also claims the benefit of U.S. Provisional Application Ser. No. 61/302,480, filed on Feb. 8, 2010 and entitled Modular Gardening System and Method. Each of the above-referenced applications and patents are incorporated by reference herein.

### STATEMENT REGARDING FEDERALLY-SPONSORED RESEARCH OR DEVELOPMENT

Not applicable.

### BACKGROUND OF THE INVENTION

1. Field of the Invention

The present invention relates to gardens grown on elevated rooftop surfaces and, more specifically, to a modular planting and irrigation device and system for growing horticultural plants that conserve water, store irrigation water, and provide air to the root zone of plants.

2. Description of the Related Art

One form of gardening growing in popularity involves growing a garden on the rooftop of a building, which has several widely-accepted benefits. For example, by utilizing rooftop spaces in and around heavily populated urban and/or suburban areas, the absorption of carbon dioxide emitted by cars and power plants typically utilized around such areas can be significantly increased. In addition, rooftop gardens absorb rainwater that would otherwise run off roofs and over concrete and asphalt surfaces used for driving, thereby picking up oil and other contaminants that potentially lead to downstream pollution. Moreover, rooftop gardens help keep the underlying structure cooler and help extend the life of the roof by blocking harmful ultraviolet rays. And, of course, rooftop gardens help to beautify areas that would otherwise lack greenery because of space limitations, such as downtown regions of cities.

While rooftop gardening provides a very compelling list of benefits, it is also problematic with regard to installation and maintenance. For example, rooftop gardens utilizing soil as a growth medium must provide for drainage as non-drained soil loses all of the air in its pore space, thus causing the plants to rot in the resulting anaerobic conditions. The requirement for drainage means that rooftop gardens must be watered frequently—perhaps as often as twice per day depending on growing conditions and the limited amount of soil that can be located on rooftops. Moreover, a typical rooftop garden must have an additional infrastructure to insure that any water which exceeds the field capacity of the soil is removed.

Another problem with rooftop gardens relates to limitations on the amount of soil that can be used. A typical rooftop garden is up to approximately twenty-four inches deep and is made up of soil, drainage layers, and various structural elements. This depth provides less than one half cubic foot of soil per square foot, which is a volume-to-area ratio capable of containing very little water to support plant life. While the depth of the soil can be increased to retain a larger amount of water, adding additional soil makes weight an issue: Wet soil can weigh up to two hundred fifty pounds per square foot, but the roofs of most buildings are not designed to support such a load, and reinforcing the roof is usually not economically feasible.

The frequent watering limitation, weight limits, and drainage requirements have greatly limited the installation of “green roofs” due to the expense of addressing these issues and the time required to install these systems and additional infrastructure. There have, however, been attempts to make installation easier and more cost effective.

For example, one such approach includes use of a drained plastic pan that is filled with a combination of rocks and light soil. According to this method, the plastic pan is pre-planted with plants that have the ability to survive low water conditions, such as sedums. While this approach does generally cut down installation time and lessen the load on the underlying roof, this technique still typically exceeds the standard load for a roof and requires extensive drainage. In addition, these plants provide less than optimal transpiration, which translates to less carbon absorption and cooling effect compared to other types of plants.

It is therefore desirable to overcome the above-described limitations of current rooftop gardening devices and systems while providing a plentiful supply of air to the roots of plants with no drainage in a comparatively lightweight material.

### SUMMARY OF THE INVENTION

The present invention is a modular planting and irrigation device and system that includes a body of porous material. Suitable porous materials include polyether polyurethane foam material, bonded crumb rubber with a polyurethane binder, or any material with the properties and ability to trap air and allow roots to grow through the material. The porous material allows movement of irrigation water through the body while trapping air in the pore spaces. The trapped air is then available to the root system of the plants that will grow within the material.

Although preferably a single piece of porous material, the body of porous material may be multiple pieces of porous material placed laterally and/or vertically adjacent to one another. For example, the body of porous material may include multiple laterally adjacent pieces of porous material. Alternatively, the body of porous material may be multiple vertically adjacent pieces of porous material, such that a first layer is placed atop one or more additional layers.

Moreover, a plurality of modular planting and irrigation devices as described herein may be combined into a system of modular planting and irrigation devices by locating the plurality of devices on a surface, such as a rooftop, in a predetermined configuration. Each of the plurality of devices is then interconnected, and the plurality is connected, to a water source using distribution piping.

The device preferably comprises a water-impermeable barrier adjacent the sides and bottom of the body of porous material. The barrier can be a polyethylene plastic liner, spray on waterproofing material, or any other suitable moisture barrier on the bottom and sides of the body. In one embodiment, the fluid inlet for the body is the top surface of the body which can be exposed to water in any traditional manner, such as hand watering with a hose and spray attachment. In alternative embodiment of the present invention, the fluid inlet can be a non-flow controlled inlet, a flow regulating device, or any means to allow water to enter the body.

One embodiment of the present invention is assembled as follows. First, a body of open cell reticulated polyether polyurethane foam material is surrounded on the sides and bottom by a water impermeable barrier and placed on a rooftop. The body is approximately two inches deep. A fluid inlet is attached through the water impermeable barrier. One or more slits are positioned in the top surface of the body, and the roots and/or root balls of selected plants are positioned in the slits. After planting, the material is irrigated, such as by filling the body to the top of the barrier or by connecting the fluid inlet to a water source. In addition to the foregoing description, the reader is referred to U.S. patent application Ser. No. 12/417,259, filed Apr. 2, 2009 and incorporated by reference herein, which describes similar application of a body of porous material used with hanging baskets.

The present invention provides at least the following advantages over other rooftop gardening systems. There is no requirement for drainage, as there is no drainage when watering the system. The present invention retains the maximum amount of water possible, with no waste created by overflow zones and drainage mechanisms. The body of porous material evenly retains air throughout, making air available to plant roots growing therethrough. The pore sizes of the porous material are such that the roots of the plants easily grow therein. The present invention is lightweight and requires minimal or no roof reinforcement. Therefore, the system can be installed without the use of heavy equipment. Finally, a larger variety of transpiration plants may be used.

Although this invention has been described in connection with rooftop planting and gardening, it can readily be seen that this invention can be used in many applications and on many surfaces providing the same advantages. For example, the invention can be used on a ground surface such as landscaped gardens or it can be used for hanging baskets or virtually any surface where growth of plants is desired.

### BRIEF DESCRIPTION OF THE DRAWINGS

FIG. 1 is a top elevation of a body of the preferred embodiment of the present invention.

FIG. 2 is a side sectional elevation of the preferred embodiment of the present invention through section line 2-2 of FIG. 1.

FIG. 3 is an enlarged side sectional elevation through section line 3-3 of FIG. 2.

FIG. 4 is a side sectional elevation of an alternative embodiment of the present invention.

FIG. 5 is a side elevation of various shaped modular planting and irrigation devices.

FIG. 6 shows a modular planting and irrigation system installed on a rooftop of a building.

### DESCRIPTION OF THE INVENTION

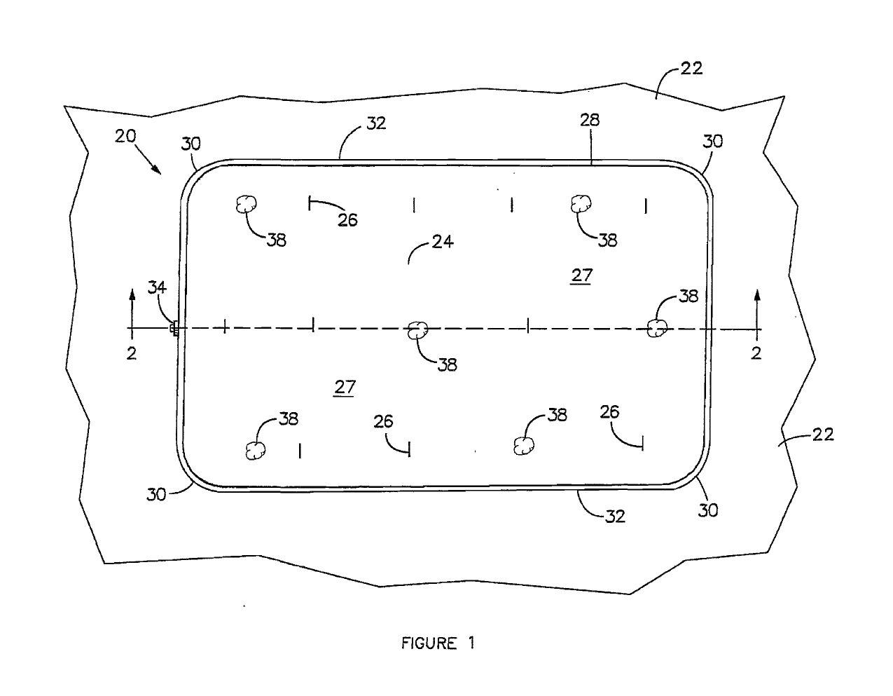

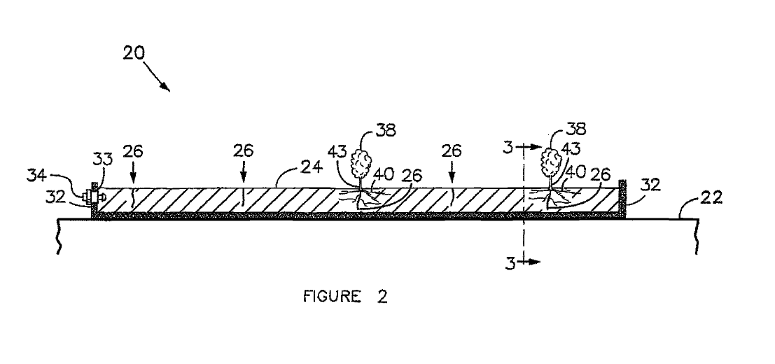

The present invention provides a modular planting and irrigation device 20 for plants that maintains air within the plants' rooting area with no need for drainage. FIG. 1 is a top elevation of the preferred embodiment of the modular device 20 on a surface, such as a rooftop 22. FIG. 2 is a partial sectional view of the preferred embodiment through section line 2-2 of FIG. 1. The modular device 20 comprises a body of porous material 24 (e.g., an open cell polyether polyurethane foam). A water impermeable barrier 32 is positioned adjacent the side and bottom surfaces of the body 24 and the entire structure is positioned on the rooftop 22. A plurality of plant receiving openings are formed as slits 26 through the top surface 27 of the body 24, but in alternative embodiments, the plant receiving openings can be sized in a variety of diameters and arrangements as deemed optimal for a particular installation of the present invention. The roots 40 of selected plants 38 can grow within the body of porous material 24 with the stems 43 extending up from the slits 26. When inserted into the slits 26, the roots 40 may be bare or accompanied with soil in the form of a root ball.

In the preferred embodiment, the body of porous material 24 is in the shape of a flat panel or layer having a height or depth of approximately two inches. However, it is anticipated that the height or depth could vary, depending on the type of plants to be planted. The length and width of the body 24 will vary with the size and shape of the surface area on which the plants are to be located, such as the available surface area of a rooftop 22.

Referring specifically to FIG. 1, the outer perimeter 28 of the barrier 32 is rectangular with rounded corners 30. Although the shape of the device 20 could also be round, square, or irregular depending on the particular characteristics of the environment into which the device 20 is to be located. In addition, in the preferred embodiment, the barrier 32 is a tray made of a polymer material having sidewalls and a bottom surface. Preferably, the sidewalls of the barrier 32 extend slightly above the sides of the body of porous material 24 (See, FIG. 2), which is fixed to the barrier 32 with an adhesive or other forms of attachment known in the art.

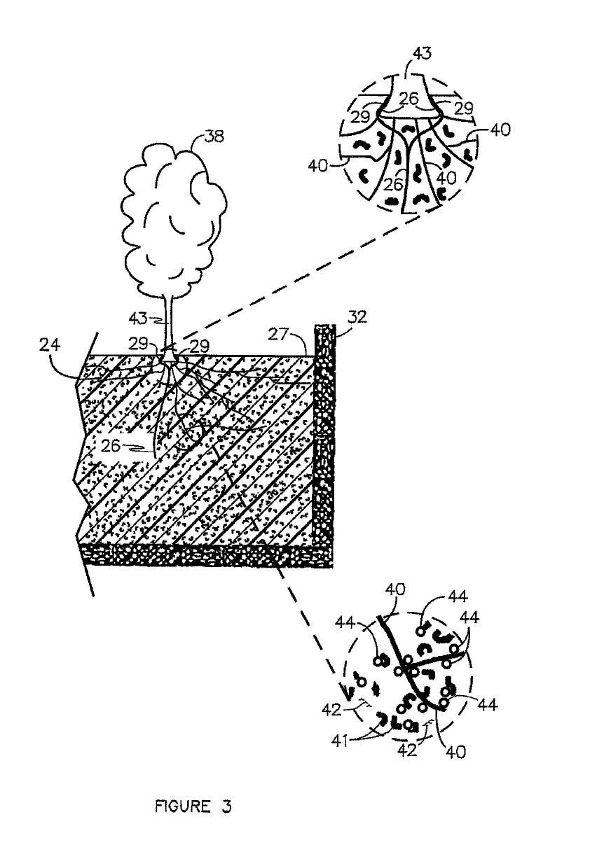

Referring to FIGS. 2 and 3, the water-impermeable barrier 32 allows the body of porous material 24 to be filled completely to the top with no loss of water from drainage. A fluid emission device 24 in the form of a drip emitter for connection to a water source (not shown) is associated with a fluid inlet for the modular planting and irrigation device 20. In this embodiment, the fluid inlet is an opening 33 through a sidewall of the water-impermeable barrier and the fluid emission device 34 is disposed through the sidewall at that opening 33. As an alternative to the drip emitter 34, the fluid emission device may be any apparatus sufficient to emit water into the body of porous material 24, such as a flow control disk or even a simple garden hose. Likewise, the fluid inlet may simply be the top surface 27 of the body 24.

In the preferred embodiment, when filled with water, the body of porous material 24 and barrier 20 together typically weighs less than ten pounds per square foot, which allows it to be installed on existing and new building rooftops, vertical walls, fencing, lattice, or other structures with no additional structural support systems required. In addition, the lightweight nature of the device 20 allows installation in a variety of orientations, such as vertically.

Referring again to FIGS. 2 & 3, in the preferred embodiment, sidewalls 29 of the slit 26 can be pulled apart to create a larger opening for insertion of the plant 38 or plant root ball (not shown). After insertion, sidewalls 29 of the slit 26 close around the inserted plant 38 or plant root ball so that the plant 38 is held secure. The pore size of the material is such that the roots 40 of the plant 38 can easily grow into and through the pores 41 and have access to the water 42 and air 44 that is contained and trapped within the pores of the material. After irrigation, the body of porous material 24 contains ample amounts of readily available water 42 and air 44 forming an optimal growth medium and structure in which the roots of the plants 38 can grow. Because the air 44 is trapped within the body of porous material 24, there is no need for any drainage infrastructure.

Although preferably a single piece of porous material, the body of porous material 24 may be multiple pieces of porous material placed laterally and/or vertically adjacent to one another. For example, the body of porous material 24 may include multiple laterally adjacent pieces of porous material.

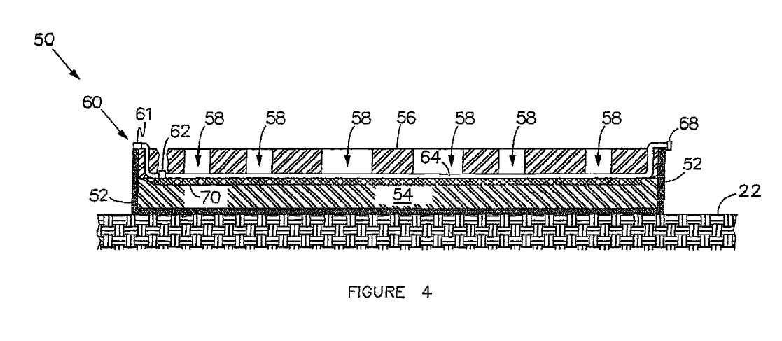

Alternatively, the body of porous material may be multiple vertically adjacent pieces of porous material, such that a first layer is placed atop a second layer. For example, FIG. 4 is a side sectional elevation of an alternative embodiment of a modular planting and irrigation device 50 that is located on a rooftop surface 22. The modular device 50 includes a water-impermeable barrier 52 made of a polymer material, a first layer 54 of porous material and a second layer 56 of porous material above the first layer 54. The second layer 56 has a plurality of plant receiving openings 58 disposed therethrough. A fluid emission system 60 for connection to a pressurized water source (not shown) is positioned in the modular device 50. Preferably, the fluid emission system includes first fitting 61 and an emission device 62 connected to a distribution tubing 64. The tubing 64 traverses the modular device 50 between the first layer 54 of porous material and the second layer 56 of porous material. Preferably, the distribution tubing 64 is a PVC pipe segment with one or more outlets (not shown) to allow fluid to flow from the distribution tubing 64 into the surrounding porous material. The emission device 62 may be any device sufficient to emit water into the porous material, such as the drip emitter described with reference to FIGS. 1 & 2. The distribution tubing is preferably made of a polyethylene material, but any suitable material for the distribution of water may be used. An end of the distribution tubing 64 terminates with a second fitting 68 that can be either capped or connected to additional distribution tubing, and leading to another modular device 50.

In this embodiment, the plant receiving openings 58 typically range in diameter from two inches to twelve inches in order to accommodate various diameter bedding and landscape plants, but may be sized as needed to secure the desired plants in the second layer 56. For example, the plant receiving openings 58 may be slits as discussed in the preferred embodiment.

In another alternate embodiment, a layer of water absorbing polymer gel 70 can be located between the first and second layers 54, 56 of the embodiment shown in FIG. 4 to provide additional water storage. Alternatively, a water absorbing polymer gel may be introduced into the porous material during the manufacturing process. Water absorbing polymer gels absorb high quantities of water, and then slowly releases the water through osmosis. The gel polymers can come in direct contact with the roots of the plants, thus making the water easily available.

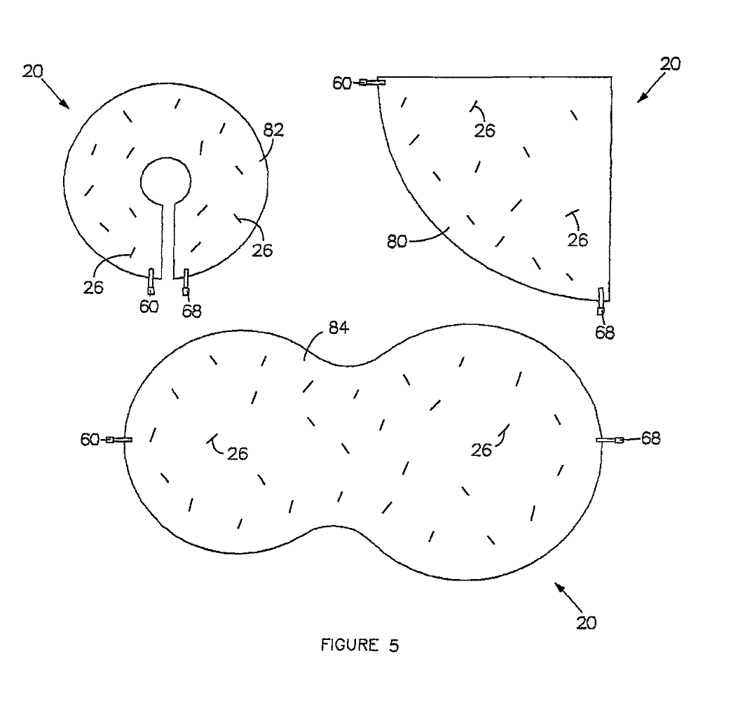

FIG. 5 is a top elevation of several embodiments of modular gardening devices 20 showing alternative shaping. The modular devices 20 can be rectangular as shown in FIG. 1, pie shaped 80, circular 82, or in an irregular shape 84. Plant receiving openings 26 are as described with reference to FIG. 1 through FIG. 3. First fitting 60 and second fitting 68 are as described with reference to FIG. 4.

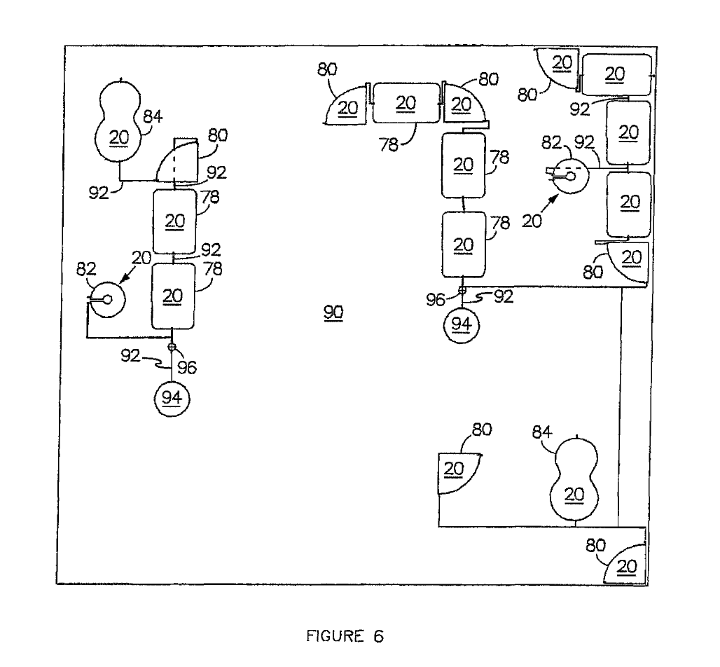

FIG. 6 shows an installation of several modular planting and irrigation devices 20 having the features described with reference to FIGS. 1-5 to compose a modular planting and irrigation system installed on a building rooftop 90. The system shown incorporates modular devices 20 having rectangular shapes 78, pie shapes 80, circular shapes 82, and irregular shapes 84, which are interconnected serially through water distribution tubing 92 when in proximity to each other, allowing fluid communication between the modular devices. Alternatively, it is anticipated that the system could incorporate some, all, or other shapes of the modular devices 20 depending on the size and configuration of the rooftop. The distribution tubing 92 is connected to a water source 94 from a pressurized water connection 96. As used herein, “fluid communication” means the movement of fluid, such as a gas or liquid, from one point to another, such as between the modular devices described with reference to FIG. 6.

The embodiments described herein include plant receiving openings, such as the slits 26, formed partially through the depth of the body of porous material. In alternative embodiments, the depth of the plant receiving openings may vary according to the size of the roots or root ball to be inserted. For example, for large roots or root balls, the plant receiving opening may be formed completely through the body of porous material 24. Other embodiments may not have any plant receiving openings. In these embodiments, roots or root balls of plants, such as those sharing geotropic roots (i.e., roots that grow downward and in response to gravity) may be placed on the top surface 27 of the body of porous material 24 without forming a plant receiving opening, after which the roots will grow downwardly into the body.

The present invention is described in terms of preferred embodiments in which a specific system and method are described. Those skilled in the art will recognize that alternative embodiments of such system, and alternative applications of the method, can be used in carrying out the present invention. Other aspects and advantages of the present invention may be obtained from a study of this disclosure and the drawings, along with the appended claims. Moreover, the recited order of the steps of the method described herein is not meant to limit the order in which those steps may be performed.

I claim:

1. A rooftop surface modular planting and irrigation device comprising:
a body of porous material;
said body of porous material having a top surface and a bottom surface;
said body of porous material having spaces configured to allow movement of irrigation water through said body and trapping of air within said body; and
a water impermeable barrier positioned between said bottom surface of said body of porous material and said rooftop surface.

2. The rooftop surface modular planting and irrigation device of claim 1 wherein said water impermeable barrier is adjacent said bottom surface.

3. The rooftop surface modular planting and irrigation device of claim 1 wherein said body of porous material is substantially continuous.

4. The rooftop surface modular planting and irrigation device of claim 1 wherein said body has sufficient depth for plant roots to grow wholly within the body of porous material.

5. The rooftop surface modular planting and irrigation device of claim 1 further comprising a fluid inlet associated with said body of porous material.

6. The rooftop surface modular planting and irrigation device of claim 1 wherein said spaces are of sufficient size to allow plant roots to grow therethrough.

7. The rooftop surface modular planting and irrigation device of claim 1 wherein said porous material is open-cell foam material.

8. The rooftop surface modular planting and irrigation device of claim 1 wherein said porous material is bonded material.

9. The rooftop surface modular planting and irrigation device of claim 1 further comprising at least one plant receiving opening disposed into said body from said body's upper surface for receiving roots of a plant.

10. The rooftop surface modular planting and irrigation device of claim 9 wherein said at least one plant receiving opening is of sufficient size to receive a root ball.

11. The rooftop surface modular planting and irrigation device of claim 5 wherein said fluid inlet is the top surface of said body of porous material.

12. The rooftop surface modular planting and irrigation device of claim 1 wherein said water impermeable barrier is also positioned adjacent sides of said body of porous material.

13. The rooftop surface modular planting and irrigation device of claim 11 wherein said water impermeable barrier material is a polymeric plastic material.

14. A modular planting and irrigation device for placement on a surface area to be planted comprising:
a body of porous material;
said body of porous material having a top surface and a bottom surface;
said body of porous material further having spaces configured to allow movement of irrigation water through said body and trapping of air within said body;
wherein said body has sufficient depth for plant roots to grow wholly within the body of porous material; and
a water impermeable barrier positioned adjacent said bottom surface.

15. The modular planting and irrigation device of claim 14 wherein said surface area to be planted is a rooftop.

16. The modular planting and irrigation device of claim 14 wherein said surface area to be planted is ground surface.

17. The modular planting and irrigation device of claim 14 wherein said body of porous material is substantially continuous.

18. The modular planting and irrigation device of claim 14 further comprising a fluid inlet associated with said body of porous material.

19. The modular planting and irrigation device of claim 14 wherein said spaces are of sufficient size to allow plant roots to grow therethrough.

20. The modular planting and irrigation device of claim 14 wherein said porous material is webbed material.

21. The modular planting and irrigation device of claim 14 wherein said porous material is open-cell foam material.

22. The modular planting and irrigation device of claim 14 wherein said porous material is bonded material.

23. The modular planting and irrigation device of claim 22 wherein said bonded material is bonded crumb rubber.

24. The modular planting and irrigation device of claim 22 wherein said bonded material is bonded with a polyurethane material.

25. The modular planting and irrigation device of claim 14 further comprising at least one plant receiving opening disposed into said body from said body's upper surface for receiving roots of a plant.

26. The modular planting and irrigation device of claim 25 wherein at least one plant receiving opening is a plurality of plant receiving openings.

27. The modular planting and irrigation device of claim 25 wherein said at least one plant receiving opening is of sufficient size to receive a root ball.

28. The modular planting and irrigation device of claim 26 wherein said at least one plant receiving opening is a slit having sidewalls.

29. The modular planting and irrigation device of claim 27 wherein said sidewalls of said slit can be pulled apart to receive roots of a plant.

30. The modular planting and irrigation device of claim 25 wherein said body of porous material comprises multiple layers of porous material and said at least one plant receiving opening is within said one layer of said multiple layers of porous material.

31. The modular planting and irrigation device of claim 18 wherein said fluid inlet is the top surface of said body of porous material.

32. The modular planting and irrigation device of claim 18 further comprising a fluid emission device associated with the body of porous material.

33. The modular planting and irrigation device of claim 31 wherein said fluid emission device is a drip emitter.

34. The modular planting and irrigation device of claim 14 wherein said barrier is positioned adjacent sides of said body of porous material.

35. The modular planting and irrigation device of claim 33 wherein said bather material is closed-cell foam.

36. The modular planting and irrigation device of claim 33 wherein said barrier material is a polymeric plastic material.

37. The modular planting and irrigation device of claim 14 wherein said barrier material is closed-cell foam.

38. The modular planting and irrigation device of claim 14 wherein said barrier material is a polymeric plastic material.

39. A method of modular planting and irrigation on a rooftop surface comprising the steps of:
positioning at least one body of porous material on a rooftop surface;
supplying irrigation water substantially throughout said at least one body of porous material;
blocking the movement of irrigation water at the bottom surface of said body of porous material with a water impermeable barrier; and
trapping air in said at least one body of porous material.

40. The method of claim 38 further comprising the step of forming at least one plant receiving opening in the top surface of said at least one body of porous material.

41. The method of claim 39 wherein said at least one plant receiving opening is a slit.

42. The method of claim 39 further comprising placing roots of at least one plant in said at least one plant receiving opening to allow the roots to grow within said at least one body of porous material.

43. The method of claim 38 wherein said at least one body of porous material is open cell foam material.

44. The method of claim 38 wherein said porous material is bonded material.

45. The method of claim 32 wherein said bonded material is crumb rubber.

46. The method of claim 38 further comprising the step of blocking the movement of irrigation water at substantially all side surfaces of said at least one body of porous material.

47. The method of claim 38 further comprising controlling the supply of irrigation water with an emission device.

48. The method of claim 38 wherein said at least one body of porous material is a plurality positioned in different locations on the rooftop surface.

49. The method of claim 47 further comprising the step of interconnecting the plurality of bodies of porous material to allow fluid communication between the bodies of porous material.

50. A rooftop surface modular planting and irrigation system comprising:
a plurality of modular planting and irrigation devices positioned on a rooftop surface, each device of said plurality of devices comprising:
a body of porous material;
said body of porous material having a top surface and a bottom surface;
said body of porous material further having spaces configured to allow movement of irrigation water through said body and trapping of air within said body;
a water impermeable barrier positioned at said bottom surface; and
wherein two or more of said modular planting and irrigation devices are in fluid communication with each other.

51. A method of installing a planting bed on a rooftop surface, the method comprising the steps of:
positioning a body of porous material on a rooftop surface in an area which is to contain plants;
positioning one or more plants in relation to the body such that the plant's roots can grow in the body; and
blocking the movement of water at a bottom surface of said panel with a water impermeable barrier.

52. The method of claim 50 further comprising the step of creating one or more plant receiving openings in the body.

53. The method of claim 51 wherein said one or more plant receiving openings are slits through the top surface of the panel.

54. The method of claim 50 wherein said positioning of said plants in relation to said body further comprises the step of positioning said plant's roots within said plant receiving openings.

55. The method of claim 50 further comprising the steps of blocking the movement of water at sides of the body with said water impermeable barrier.

56. The method of claim 50 wherein said body of porous material is open cell foam material.

57. The method of claim 50 wherein said body of porous material is bonded material.

58. The method of claim 50 further comprising the step of positioning a water supply conduit to direct irrigation water into the panel at a fluid inlet.

59. The method of claim 56 wherein said fluid inlet is the top surface of the panel.
